(19) United States
(12) Patent Application Publication
(10) Pub. No.: US 2024/0396888 A1
(43) Pub. Date: Nov. 28, 2024

(54) One-Time Password Activation Using Read Receipts

(71) Applicant: International Business Machines Corporation, Armonk, NY (US)

(72) Inventor: Vignesh Manivannan, Vellore (IN)

(21) Appl. No.: 18/322,792

(22) Filed: May 24, 2023

(51) Int. Cl. H04L 9/40

(52) U.S. Cl. CPC H04L 63/0838; H04L 63/0846

(57) ABSTRACT

A computer implemented method manages passwords. A number of processor units receives a password request for a one-time password from a user. The number of processor units sends the one-time password with a message request for a read receipt to the user. The number of processor units activates the one-time password in response to receiving the read receipt from the user.

### BACKGROUND

The disclosure relates generally to an improved computer system and more specifically to managing passwords.

Security for accessing resources over a network such as the Internet is important to protect information and prevent unauthorized access to resources. These resources can be, for example, websites, server computers, storage systems, email services, and other types of resources.

Multifactor authentication is an example of a security measure that provides additional protection in addition to typical password-based authentication system used to verify the identity of users and provide access to resources. With a multifactor authentication system, multiple forms of authentication mechanisms provide access to resources.

A multifactor authentication system can use a one-time password (OTP) as one of the factors in increasing security. The use of a one-time password provides extra security in addition to a static user ID and password. The one-time password can be generated in response to a user entering a valid user ID and password. This one-time password is sent to the user. In turn, the user enters the one-time password. Entry of the correct one-time password results in access being granted to the resource.

### SUMMARY

According to one illustrative embodiment, a computer implemented method manages passwords. A number of processor units receives a password request for a one-time password from a user. The number of processor units sends the one-time password with a message request for a read receipt to the user. The number of processor units activates the one-time password in response to receiving the read receipt from the user. According to other illustrative embodiments, a computer system and a computer program product for managing passwords are provided.

### BRIEF DESCRIPTION OF THE DRAWINGS

FIG. 1 is a block diagram of a computing environment in accordance with an illustrative embodiment;

FIG. 2 is a block diagram of a password environment in accordance with an illustrative embodiment;

FIG. 3 is a flowchart of a process for managing passwords in accordance with an illustrative embodiment;

FIG. 4 is a flowchart of process for processing a repeated request for a one-time password in accordance with an illustrative embodiment;

FIG. 5 is a flowchart of process for sending a one-time password in accordance with an illustrative embodiment; and

FIG. 6 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

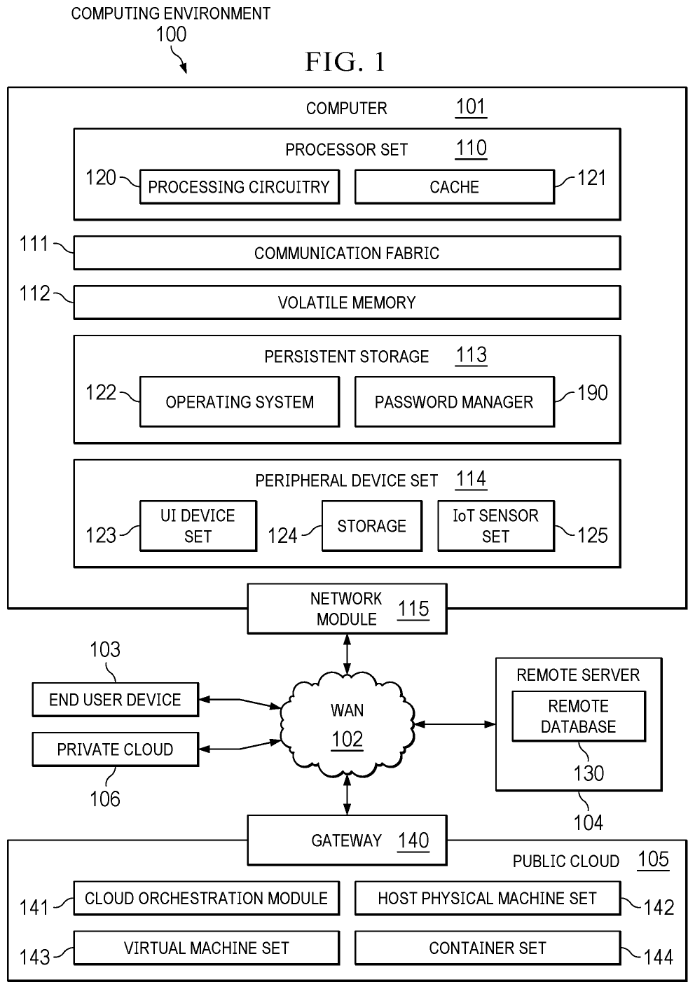

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as password manager 190. In addition to password manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and password manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in password manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in password manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative examples recognize and take into account a number of different considerations as described herein. One-time passwords are a useful feature in multifactor authentication. These one-time passwords can be sent to various applications such as an email application, text message application, chat application, or other applications.

In some cases, the user may not receive the message containing the one-time password. A scenario such as a network outage can result in the message not reaching the user. In yet another example, the server sending the message may have scheduled maintenance, storage issues, or other issues that may delay sending of the one-time password.

With this situation, the user may repeat requesting the one-time password because the user has not yet seen the one-time password. As a result, the user may receive multiple messages with different one-time passwords. Depending on the type of one-time password system, previously generated one-time passwords may be marked as invalid when a new one-time password is generated. As result, messages containing previous one-time passwords cannot be used for authentication. Reviewing multiple messages to find an active one-time password can be frustrating especially if the most recent password has been delayed and not received by the user.

Thus, illustrative examples provide a computer implemented method, apparatus, system, and computer program product for managing passwords. In one illustrative example, a number of processor units receives a password request for a one-time password from a user. The number of processor units sends the one-time password with a message request for a read receipt to the user. The number of processor units activates the one-time password in response to receiving the read receipt from the user.

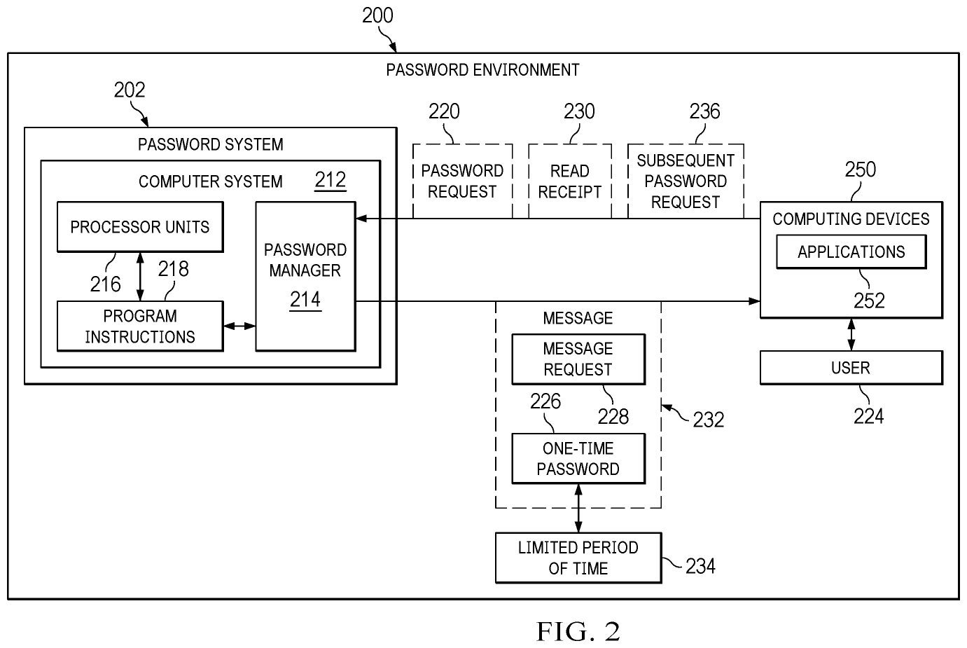

With reference now to FIG. 2, a block diagram of a password environment is depicted in accordance with an illustrative embodiment. In this illustrative example, password environment 200 includes components that can be implemented in hardware such as the hardware shown in computing environment 100 in FIG. 1.

In this illustrative example, password system 202 can manage the distribution and activation of passwords. In this example, password system 202 comprises computer system 212 and password manager 214. Password manager 214 is located in computer system 212.

Password manager 214 can be implemented in software, hardware, firmware or a combination thereof. When software is used, the operations performed by password manager 214 can be implemented in program instructions configured to run on hardware, such as a processor unit. When firmware is used, the operations performed by password manager 214 can be implemented in program instructions and data and stored in persistent memory to run on a processor unit. When hardware is employed, the hardware can include circuits that operate to perform the operations in password manager 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program code that operate a computer. A processor unit can be implemented using processor set 110 in FIG. 1. When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different type of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, password manager 214 receives password request 220 for one-time password 226 from user 224. In response, password manager 214 sends one-time password 226 with message request 228 for read receipt 230 to the user 224.

In this example, one-time password 226 with message request 228 is sent in message 232. Message 232 can take a number of different forms. For example, message 232 can be selected from a group comprising an email message, a text message, a chat message, an instant messaging message, and other types of messages.

Password manager 214 activates one-time password 226 in response to receiving read receipt 230 from user 224. In this illustrative example, read receipt 230 can be generated automatically in response to one of opening message 232, viewing a message content in in message 232, a user input to message 232, and other events with respect to message 232. In other examples, read receipt 230 can be generated by the user returning a reply.

In this example, one-time password 226 is valid for a limited period of time 234 in response to one-time password 226 being activated. Limited period of time 234 can take a number of different forms. For example, limited period of time 234 can be 2 minutes, 1 hour, 24 hours, or some other period of time.

In this illustrative example, password manager 214 may receive subsequent password request 236 for a new one-time password from user 224. In this example, password manager 214 sends one-time password 226 with message request 228 for read receipt 230 in response to receiving the subsequent request. In other words, password manager 214 sends the same one-time password in response receiving subsequent password request 236 instead of generating a new one-time password. As result, if two or more messages with one-time password 226 is received by user 224, user 224 can activate the one-time password from any of the messages that are received through the return of read receipt 230.

As depicted, user 224 can send requests, receive one-time passwords, and other information using a set of computing devices 250. For example, one-time password 226 can be sent to a different computing device in the computing devices 250 from computer device in computing devices 250 sending password request 220 for one-time password 226.

As used herein, a “set of” when used with reference items means one or more items. For example, set of computing devices is one or more computing devices. In these illustrative examples, the set of computing devices 250 can be any device that can communicate with computer system 212 and can process data. The set of computing devices 250 can be selected from at least one of a mobile phone, a laptop computer, a desktop computer, an Internet of Things device, a smartwatch, or some other suitable type of device.

Additionally, applications 252 can run on the set of computing devices 250. One-time password 226 can be sent to a different application in applications 252 from the application in applications 252 sending password request 220 for one-time password 226.

In one illustrative example, one or more technical solutions are present that overcome a problem with the sending of a one-time password in which a delay of the one-time password causes additional requests for one-time password to be made. In these illustrative examples, the user does not need to determine which message contains the valid one-time password if multiple messages are received in response to making multiple requests for a one-time password. In the illustrative examples, the one-time password is reset on subsequent requests if one-time password is not yet been activated.

As a result, all of the messages received by the user contain a valid one-time password with activation of the one-time password occurring in response returning a read receipt. Additionally, time and frustration with a user determining which one-time password is valid when multiple messages with one-time passwords are received can be reduced or eliminated in the illustrative examples.

Further, this process also reduces issues in which a new one-time password has been issued in response to a subsequent request but not been received by the user. With current processes for managing one-time passwords, the passwords perceived by the user are no longer valid, but the new one-time password has not been received because of delays. In the illustrative examples, the same one-time password is sent with a request for a read receipt. As result, the one-time password is not activated or invalidated until the user actually receives and a read receipt is returned.

Computer system 212 can be configured to perform at least one of the steps, operations, or actions described in the different illustrative examples using software, hardware, firmware or a combination thereof. As a result, computer system 212 operates as a special purpose computer system in which password manager 214 in computer system 212 enables managing one-time passwords in a manner that reduces repeatedly creating new passwords for a user in response to repeated requests for a password caused by delays in sending passwords to the user. In particular, password manager 214 transforms computer system 212 into a special purpose computer system as compared to currently available general computer systems that do not have password manager 214.

In the illustrative example, the use of password manager 214 in computer system 212 integrates processes into a practical application for method that manages one-time passwords that reduces creating new one-time passwords each time a request has been made when a previous one-time password has not yet been activated.

The illustration of password environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, a different application and applications 252 can be used to send requests from the application that receives one-time passwords. For example, password request 220 can be sent using a browser. Message 232 containing one-time password 226 with message request 228 can be received by a text message program, an instant message program, an email application, or some other suitable application.

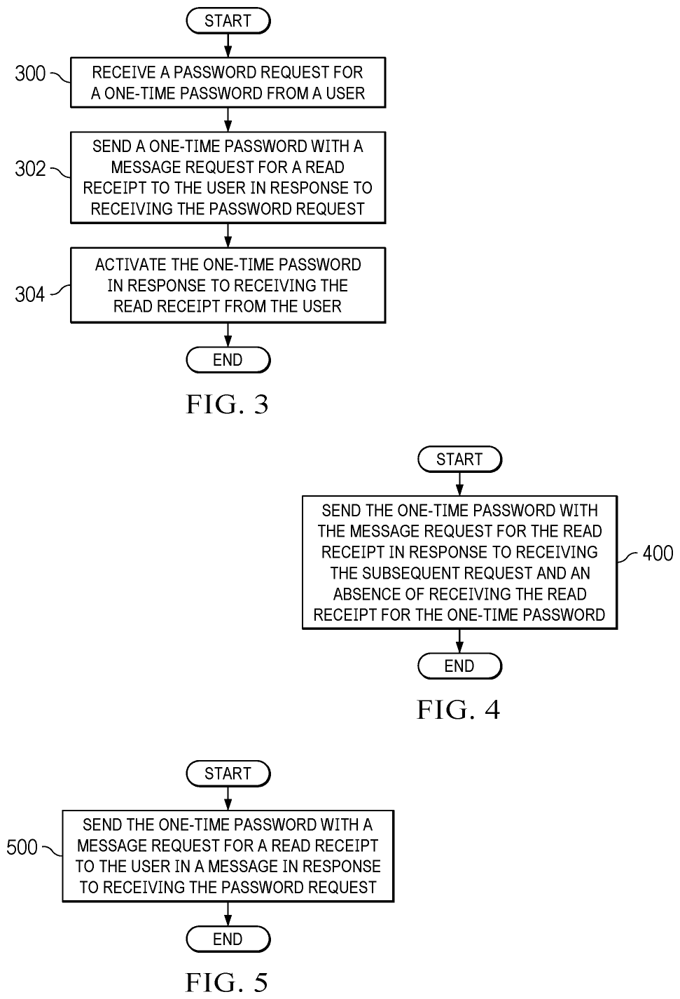

Turning next to FIG. 3, a flowchart of a process for managing passwords is depicted in accordance with an illustrative embodiment. The process in FIG. 3 can be implemented in hardware, software, or both. When implemented in software, the process can take the form of program instructions that are run by one of more processor units located in one or more hardware devices in one or more computer systems. For example, the process can be implemented in password manager 214 in computer system 212 in FIG. 2.

The process begins by receiving a password request for a one-time password from a user (step 300). The process sends a one-time password with a message request for a read receipt to the user in response to receiving the password request (step 302).

The process activates the one-time password in response to receiving the read receipt from the user (step 304). The process terminates thereafter.

With reference to FIG. 4, a flowchart of process for processing a repeated request for a one-time password is depicted in accordance with an illustrative embodiment. The process illustrated in this figure is an example of an additional step that can be performed with the steps in FIG. 3.

The process sends the one-time password with the message request for the read receipt in response to receiving the subsequent request and an absence of receiving the read receipt for the one-time password (step 400). The process terminates thereafter.

In this case, the same one-time password is sent to the user when a read receipt has not been received from a prior message sending the one-time password. In this manner, the generation of different one-time password sending multiple messages can be avoided. Further, issues with one-time passwords that are no longer valid and repeated generation of different one-time password can be avoided.

Turning to FIG. 5, a flowchart of process for sending a one-time password is depicted in accordance with an illustrative embodiment. The process illustrated in FIG. 5 is an example of an implementation for step 302 in FIG. 3.

The process sends the one-time password with a message request for a read receipt to the user in a message in response to receiving the password request (step 500). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

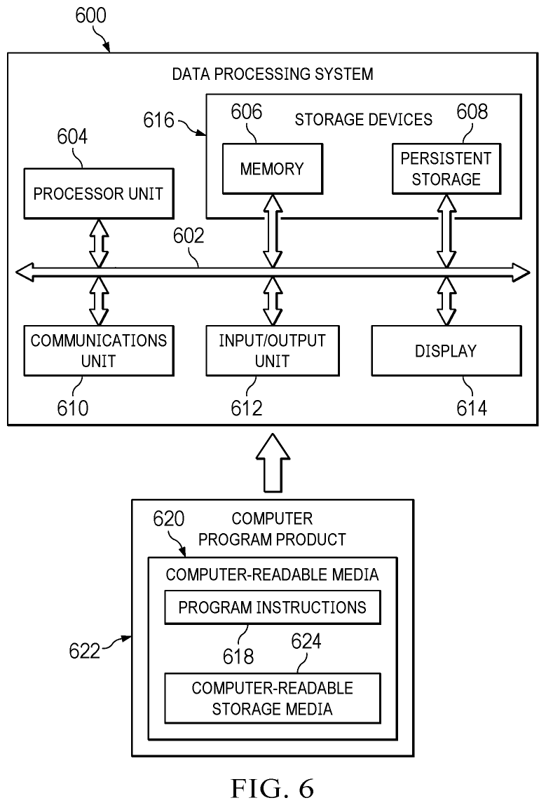

Turning now to FIG. 6, a block diagram of a data processing system is depicted in accordance with an illustrative embodiment. Data processing system 600 can be used to implement computers and computing devices in computing environment 100 in FIG. 1. Data processing system 600 can also be used to implement computer system 212 in FIG. 2. In this illustrative example, data processing system 600 includes communications framework 602, which provides communications between processor unit 604, memory 606, persistent storage 608, communications unit 610, input/output (I/O) unit 612, and display 614. In this example, communications framework 602 takes the form of a bus system.

Processor unit 604 serves to execute instructions for software that can be loaded into memory 606. Processor unit 604 includes one or more processors. For example, processor unit 604 can be selected from at least one of a multicore processor, a central processing unit (CPU), a graphics processing unit (GPU), a physics processing unit (PPU), a digital signal processor (DSP), a network processor, or some other suitable type of processor. Further, processor unit 604 can be implemented using one or more heterogeneous processor systems in which a main processor is present with secondary processors on a single chip. As another illustrative example, processor unit 604 can be a symmetric multi-processor system containing multiple processors of the same type on a single chip.

Memory 606 and persistent storage 608 are examples of storage devices 616. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 616 may also be referred to as computer readable storage devices in these illustrative examples. Memory 606, in these examples, can be, for example, a random-access memory or any other suitable volatile or non-volatile storage device. Persistent storage 608 may take various forms, depending on the particular implementation.

For example, persistent storage 608 may contain one or more components or devices. For example, persistent storage 608 can be a hard drive, a solid-state drive (SSD), a flash memory, a rewritable optical disk, a rewritable magnetic tape, or some combination of the above. The media used by persistent storage 608 also can be removable. For example, a removable hard drive can be used for persistent storage 608.

Communications unit 610, in these illustrative examples, provides for communications with other data processing systems or devices. In these illustrative examples, communications unit 610 is a network interface card.

Input/output unit 612 allows for input and output of data with other devices that can be connected to data processing system 600. For example, input/output unit 612 may provide a connection for user input through at least one of a keyboard, a mouse, or some other suitable input device. Further, input/output unit 612 may send output to a printer. Display 614 provides a mechanism to display information to a user.

Instructions for at least one of the operating system, applications, or programs can be located in storage devices 616, which are in communication with processor unit 604 through communications framework 602. The processes of the different embodiments can be performed by processor unit 604 using computer-implemented instructions, which may be located in a memory, such as memory 606.

These instructions are referred to as program instructions, computer usable program instructions, or computer readable program instructions that can be read and executed by a processor in processor unit 604. The program instructions in the different embodiments can be embodied on different physical or computer readable storage media, such as memory 606 or persistent storage 608.

Program instructions 618 are located in a functional form on computer readable media 620 that is selectively removable and can be loaded onto or transferred to data processing system 600 for execution by processor unit 604. Program instructions 618 and computer readable media 620 form computer program product 622 in these illustrative examples. In the illustrative example, computer readable media 620 is computer readable storage media 624.

Computer readable storage media 624 is a physical or tangible storage device used to store program instructions 618 rather than a medium that propagates or transmits program instructions 618. Computer readable storage media 624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 618 can be transferred to data processing system 600 using a computer readable signal media. The computer readable signal media are signals and can be, for example, a propagated data signal containing program instructions 618. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 620” can be singular or plural. For example, program instructions 618 can be located in computer readable media 620 in the form of a single storage device or system. In another example, program instructions 618 can be located in computer readable media 620 that is distributed in multiple data processing systems. In other words, some instructions in program instructions 618 can be located in one data processing system while other instructions in program instructions 618 can be located in one data processing system. For example, a portion of program instructions 618 can be located in computer readable media 620 in a server computer while another portion of program instructions 618 can be located in computer readable media 620 located in a set of client computers.

The different components illustrated for data processing system 600 are not meant to provide architectural limitations to the manner in which different embodiments can be implemented. In some illustrative examples, one or more of the components may be incorporated in or otherwise form a portion of, another component. For example, memory 606, or portions thereof, may be incorporated in processor unit 604 in some illustrative examples. The different illustrative embodiments can be implemented in a data processing system including components in addition to or in place of those illustrated for data processing system 600. Other components shown in FIG. 6 can be varied from the illustrative examples shown. The different embodiments can be implemented using any hardware device or system capable of running program instructions 618.

Thus, illustrative embodiments of the present invention provide a computer implemented method, computer system, and computer program product for managing passwords. A number of processor units receives a password request for a one-time password from a user. The number of processor units sends the one-time password with a message request for a read receipt to the user. The number of processor units activates the one-time password in response to receiving the read receipt from the user.

With the illustrative examples, issues associated with users receiving multiple one-time passwords in different messages in response to multiple requests and with invalidation of prior one-time passwords can be avoided. Thus, delays in sending one-time passwords due to network congestion or other issues do not result in users receiving different one-time passwords in different messages in which only a single one-time password is valid. The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for managing passwords, the computer implemented method comprising:
receiving, by a number of processor units, a password request for a one-time password from a user;
sending, by the number of processor units, the one-time password with a message request for a read receipt to the user in response to receiving the password request; and
activating, by the number of processor units, the one-time password in response to receiving the read receipt from the user.

2. The computer implemented method of claim 1 further comprising:
receiving, by the number of processor units, a subsequent password request for a new one-time password from the user; and
sending, by the number of processor units, the one-time password with the message request for the read receipt in response to receiving the subsequent request.

3. The computer implemented method of claim 1, wherein sending, by the number of processor units, the one-time password with a message request for a read receipt comprises:
sending, by the number of processor units, the one-time password with a message request for a read receipt to the user in a message in response to receiving the password request.

4. The computer implemented method of claim 3, wherein the message is selected from a group comprising an email message, a text message, a chat message, and an instant messaging message.

5. The computer implemented method of claim 1, wherein the one-time password is sent in a message and the read receipt is generated automatically in response to one of opening the message, viewing a message content in the message, and user input to the message.

6. The computer implemented method of claim 1, wherein the one-time password is valid for a limited period of time in response to the one-time password being activated.

7. The computer implemented method of claim 1, wherein the one-time password is sent to a different computing device from a computer device sending the password request for the one-time password.

8. The computer implemented method of claim 1, wherein the one-time password is sent to a different application from an application sending the password request for the one-time password.

9. A computer system comprising:
a number of processor units, wherein the number of processor units executes program instructions to:
receive a password request for a one-time password from a user;
send the one-time password with a message request for a read receipt to the user in response to receiving the password request; and
activate the one-time password in response to receiving the read receipt from the user.

10. The computer system of claim 9, wherein the number of processor units further executes program instructions to:
receive a subsequent password request for a new one-time password from the user; and
send the one-time password with the message request for the read receipt in response to receiving the subsequent request.

11. The computer system of claim 9, wherein in sending, by the number of processor units, the one-time password with a message request for a read receipt, the number of processor units further executes program instructions to:
send the one-time password with a message request for a read receipt to the user in message in response to receiving the password request.

12. The computer system of claim 11, wherein the message is selected from a group comprising an email message, a text message, a chat message, and an instant messaging message.

13. The computer system of claim 9, wherein the one-time password is sent in a message and the read receipt is generated automatically in response to one of opening the message, viewing a message content in the message, and user input to the message.

14. The computer system of claim 9, wherein the one-time password is valid for a limited period of time in response to the one-time password being activated.

15. The computer system of claim 9, wherein the one-time password is sent to a different client device from a client device sending the password request for the one-time password.

16. The computer system of claim 9, wherein the one-time password is sent to a different application from an application sending the password request for the one-time password.

17. A computer program product for managing passwords, the computer program product comprising a computer readable storage medium having program instructions embodied therewith, the program instructions executable by a computer system to cause the computer system to:
receive a password request for a one-time password from a user;
send the one-time password with a message request for a read receipt to the user in response to receiving the password request; and
activate the one-time password in response to receiving the read receipt from the user.

18. The computer program product of claim 17, wherein the program instructions are further executable by the computer system to cause the computer system to:
receive a subsequent password request for a new one-time password from the user; and
send the one-time password with the message request for the read receipt in response to receiving the subsequent request.

19. The computer program product of claim 17, wherein sending, by the number of processor units, the one-time password with a message request for a read receipt, the program instructions are further executable by the computer system to cause the computer system to:
send the one-time password with a message request for a read receipt to the user in message in response to receiving the password request.

20. The computer program product of claim 19, wherein the message is selected from a group comprising an email message, a text message, a chat message, and an instant messaging message.
